(19) United States
(12) Patent Application Publication
(10) Pub. No.: US 2014/0305212 A1
(43) Pub. Date: Oct. 16, 2014

(54) CIRCUIT FOR MEASURING ACCELERATION OF THREE-AXIS ACCELERATION SENSOR

(71) Applicant: Samsung Electro-Mechanics Co., Ltd., Suwon (KR)

(72) Inventor: Chang Hyun KIM, Yongin (KR)

(73) Assignee: SAMSUNG ELECTRO-MECHANICS CO., LTD., Suwon (KR)

(21) Appl. No.: 14/045,313

(22) Filed: Oct. 3, 2013

(30) Foreign Application Priority Data
Apr. 12, 2013 (KR) 10-2013-0040329

(51) Int. Cl. G01P 15/12

(52) U.S. Cl. CPC G01P 15/12
USPC 73/514.33

(57) ABSTRACT

Disclosed herein is a circuit for measuring acceleration of a three-axis acceleration sensor. The circuit for measuring acceleration of a three-axis acceleration sensor includes: three-axis acceleration sensors connected to one another in parallel and sensing the respective accelerations applied to three axes directions of X, Y, and Z axes to output corresponding signals; a demultiplexer outputting three axes signals each output from the three-axis acceleration sensors through a single path; and an amplifier amplifying the output signal from the demultiplexer, and further includes, at a back-end of the amplifier, a multiplexer distributing a signal output from the amplifier to the respective axes, a sample and hold circuit unit sampling and storing an analog signal of each axis output from the multiplexer, and an analog-to-digital converter converting an analog signal output from the amplifier into a digital signal.

### CROSS REFERENCE(S) TO RELATED APPLICATIONS

This application claims the benefit under 35 U.S.C. Section 119 of Korean Patent Application Serial No. 10-2013-0040329, entitled “Circuit for Measuring Acceleration of Three-Axis Acceleration Sensor” filed on Apr. 12, 2013, which is hereby incorporated by reference in its entirety into this application.

### BACKGROUND OF THE INVENTION

1. Technical Field

The present invention relates to a circuit for measuring acceleration of a three-axis acceleration sensor, and particularly, to a circuit for measuring acceleration of a three-axis acceleration sensor capable of minimizing a consumption current and obtaining excellent noise characteristic.

2. Description of the Related Art

A piezo-resistive acceleration sensor has a resistance value which is varied according to acceleration applied to the sensor. In this case, the acceleration applied to the sensor may be measured by measuring the varied resistance value. A three-axis acceleration sensor has been recently used for a mobile, and particularly, require low power, high performance, and low noise characteristics.

FIG. 1 is a view schematically showing a configuration of a circuit for measuring acceleration of an acceleration sensor according to the related art.

As shown in FIG. 1, the circuit for measuring acceleration of the acceleration sensor according to the related art, which is to measure the acceleration applied to the sensor, is configured of an acceleration sensor 101 in which four resistors R1 to R4 form a bridge structure, and an amplifier 102 connected to an output terminal of the acceleration sensor 101 to amplify a signal output from the output terminal of the acceleration sensor 101.

The circuit for measuring acceleration of the acceleration sensor according to the related art having the configuration described above may measure the acceleration only for any one axis among three axes of X, Y, and Z axes. Therefore, in the case in which the acceleration for all of the three axes of X, Y, and Z axes need to be measured, three circuits for measuring acceleration having the above-mentioned configuration needs to be used. As a result, manufacturing cost and current consumption of an electronic device using the above-mentioned circuit for measuring acceleration of the acceleration sensor according to the related art may be increased.

### RELATED ART DOCUMENT

### Patent Document

(Patent Document 1) Japanese Patent Laid-Open Publication No. 1996-178951 (laid-open published on Jul. 12, 1996)

### SUMMARY OF THE INVENTION

An object of the present invention is to provide a circuit for measuring acceleration of a three-axis acceleration sensor capable of minimizing a consumption current and having excellent noise characteristic by amplifying a three-axis signal through a single path and providing a circuit of simultaneously performing a function of a low-pass filter and a function of sampling and holding to a front-end of an analog-to-digital converter.

According to an exemplary embodiment of the present invention, there is provided a circuit for measuring acceleration of a three-axis acceleration sensor, including: three-axis acceleration sensors connected to one another in parallel and sensing the respective accelerations applied to three axes directions of X, Y, and Z axes to output corresponding signals; a demultiplexer outputting three axes signals each output from the three-axis acceleration sensors through a single path; and an amplifier amplifying the output signal from the demultiplexer.

The demultiplexer may have a switch for supplying a driving voltage and switches for opening and closing an output terminal of the three-axis acceleration sensor 220b configured of an interworking structure so that a voltage for driving the three-axis acceleration sensor may be applied or blocked to the three-axis acceleration sensor, and the output terminal of the three-axis acceleration sensor may be closed or opened.

The circuit for measuring acceleration of a three-axis acceleration sensor may further include, at an output terminal of the amplifier, a multiplexer distributing a signal output from the amplifier to the respective axes and a sample and hold circuit unit sampling and storing an analog signal of each axis output from the multiplexer.

According to another exemplary embodiment of the present invention, there is provided a circuit for measuring acceleration of a three-axis acceleration sensor, including: three-axis acceleration sensors connected to one another in parallel and sensing the respective accelerations applied to three axes directions of X, Y, and Z axes to output corresponding signals; a demultiplexer outputting three axes signals each output from the three-axis acceleration sensors through a single path; an amplifier amplifying the output signal from the demultiplexer; and an analog-to-digital converter receiving an analog signal output from the amplifier, converting the analog signal into a digital signal, and outputting the digital signal.

The demultiplexer may have a switch for supplying a driving voltage and switches for opening and closing an output terminal of the three-axis acceleration sensor 220b configured of an interworking structure so that a voltage for driving the three-axis acceleration sensor may be applied or blocked to the three-axis acceleration sensor, and the output terminal of the three-axis acceleration sensor may be closed or opened.

The amplifier may be further installed with an offset rejection circuit for rejecting an offset in the case in which the three-axis acceleration sensor has the offset.

The circuit for measuring acceleration of a three-axis acceleration sensor may further include, between the amplifier and the analog-to-digital converter, a multiplexer distributing a signal output from the amplifier to the respective axes and a sample and hold circuit unit sampling and storing an analog signal of each axis output from the multiplexer.

The sample and hold circuit unit may be further provided with a low pass filter unit for removing a high frequency noise mixed in the output signal of the three-axis acceleration sensor received through the multiplexer.

A second demultiplexer receiving three axes signals from the sample and hold circuit unit and outputting the three axes signals through a single path may be further installed between the sample and hold circuit unit and the analog-to-digital converter.

### BRIEF DESCRIPTION OF THE DRAWINGS

FIG. 1 is a view schematically showing a configuration of a circuit for measuring acceleration of an acceleration sensor according to the related art;

FIG. 2 is a view schematically showing a configuration of a circuit for measuring acceleration of a three-axis acceleration sensor according to a first exemplary embodiment of the present invention;

FIG. 3 is a view schematically showing a configuration of a circuit for measuring acceleration of a three-axis acceleration sensor according to a second exemplary embodiment of the present invention;

FIG. 4 is a view schematically showing a configuration of a circuit for measuring acceleration of a three-axis acceleration sensor according to a third exemplary embodiment of the present invention; and

FIG. 5 is a view schematically showing a configuration of a circuit for measuring acceleration of a three-axis acceleration sensor according to a fourth exemplary embodiment of the present invention.

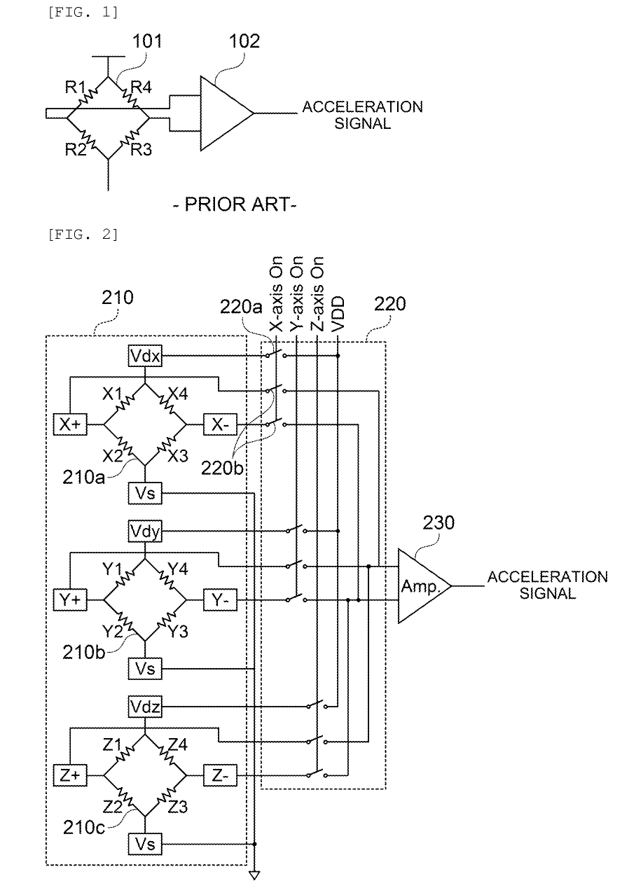

### DESCRIPTION OF THE PREFERRED EMBODIMENTS

Terms and words used in the present specification and claims are not to be construed as a general or dictionary meaning, but are to be construed to meaning and concepts meeting the technical ideas of the present invention based on a principle that the inventors can appropriately define the concepts of terms in order to describe their own inventions in the best mode.

Throughout the present specification, unless explicitly described to the contrary, “comprising” any components will be understood to imply the inclusion of other elements rather than the exclusion of any other elements. A term “part”, “module”, “device”, or the like, described in the specification means a unit of processing at least one function or operation and may be implemented by hardware or software or a combination of hardware and software.

Hereinafter, exemplary embodiments of the present invention will be described in detail with reference to the accompanying drawings.

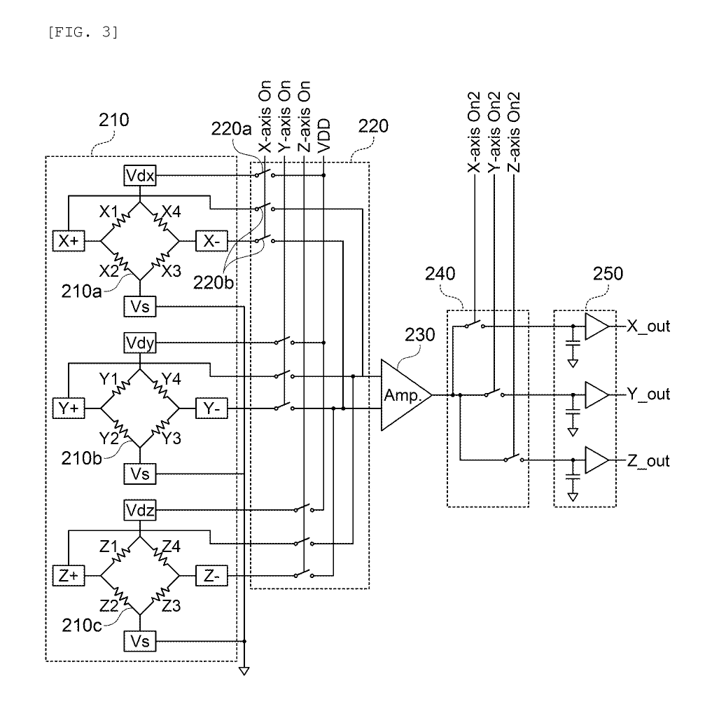

FIG. 2 is a view schematically showing a configuration of a circuit for measuring acceleration of a three-axis acceleration sensor according to a first exemplary embodiment of the present invention.

Referring to FIG. 2, the circuit for measuring acceleration of the three-axis acceleration sensor according to the first exemplary embodiment of the present invention is configured to include a three-axis acceleration sensor 210, a demultiplexer 220, and an amplifier 230.

The three-axis acceleration sensor 210 is configured of an X axis acceleration sensor 210a, a Y axis acceleration sensor 210b, and a Z axis acceleration sensor 210c connected to one another in parallel and senses the acceleration applied to three axes directions of X, Y, and Z axes, respectively, to thereby output a corresponding signal. Here, each of the acceleration sensors 210a, 210b, and 210c of the X, Y, and Z axes has a configuration in which the respective four resistors X1 to X4, Y1 to Y4, and Z1 to Z4 each form a bridge structure.

The demultiplexer 220 outputs signals of the three axes of X, Y, and Z each output from the three-axis acceleration sensor 210 through a single path. Here, the above-mentioned demultiplexer 220 may have a switch 220a for supplying a driving voltage and switches 220b for opening and closing an output terminal of the three-axis acceleration sensor 210 configured of an interworking structure so that a voltage for driving the three-axis acceleration sensor 210 may be applied or blocked to the three-axis acceleration sensor 210, and the output terminal of the three-axis acceleration sensor 210 may be closed or opened.

The amplifier 230 amplifies an output signal from the three-axis acceleration sensor 210 output through the demultiplexer 220.

The circuit for measuring acceleration of the three-axis acceleration sensor according to the first exemplary embodiment of the present invention having the configuration as described above may decrease a consumption current of a circuit for a signal processing to ⅓ or less by amplifying the signals of the three axes of X, Y, and Z axes through the single path. In addition, Vdx, Vdy, and Vdz, which are voltages for driving the respective sensors are also applied only when driving the sensor, thereby making it possible to decrease the consumption current.

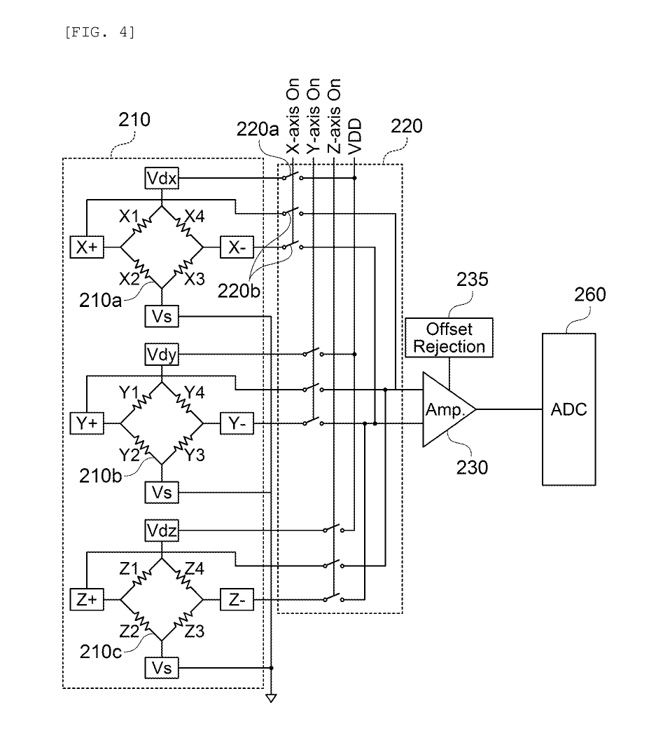

FIG. 3, which shows a configuration of a circuit for measuring acceleration of a three-axis acceleration sensor according to the second exemplary embodiment of the present invention, basically includes the three-axis acceleration sensor 210, the demultiplexer 220, and the amplifier 230, similarly to the case of the first exemplary embodiment of the present invention. In addition, the circuit for measuring acceleration of a three-axis acceleration sensor according to the second exemplary embodiment of the present invention further includes a multiplexer 240 distributing the signal output from the amplifier 230 to the output terminal of the amplifier 230 so as to separately process the signal output from the amplifier 230 with respect to each of the X, Y, and Z axes, and a sample and hold circuit unit 250 sampling an analog signal of each axis output from the multiplexer 240 and storing (maintaining) the analog signal by a predetermined time. The second exemplary embodiment of the present invention as described above may be useful in the case in which a digital signal is obtained by converting the analog signal output from the amplifier (that is, the case in which the signal is digitized using an analog-to-digital converter). The reason is that when a converting time is insufficient in digitizing the signal using the analog-to-digital converter (A/D converter), a case which is not capable of converting the signal may be generated and the signal needs to be extended to a time required for processing accordingly. Therefore, a circuit converting, specifically, sampling a continuous waveform into a non-continuous waveform, and maintaining (holding) the sampled waveform by a predetermined time, that is, a sample and hold circuit is required.

Meanwhile, FIG. 4 is a view schematically showing a configuration of a circuit for measuring acceleration of a three-axis acceleration sensor according to a third exemplary embodiment of the present invention.

Referring to FIG. 4, the circuit for measuring acceleration of the three-axis acceleration sensor according to the third exemplary embodiment of the present invention basically and equally includes the three-axis acceleration sensor 210, the demultiplexer 220, and the amplifier 230, similarly to the case of the first exemplary embodiment (see FIG. 2) of the present invention described above. Therefore, a description for the same components will be omitted and only different components will be described.

That is, the third exemplary embodiment of the present invention basically includes the three-axis acceleration sensor 210, the demultiplexer 220, and the amplifier 230, and includes, at a back-end of the amplifier 230, an analog-to-digital converter (ADC) 260 receiving the analog signal output from the amplifier 230, converting it into the digital signal, and outputting the digital signal.

Here, the amplifier 230 is installed with an offset rejection circuit 235 for rejecting an offset in the case in which the three-axis acceleration sensor 210 has the offset.

The above-mentioned third exemplary embodiment of the present invention may be a form useful for an electronic device widely using a digital output value recently.

Meanwhile, in the above-mentioned circuit for measuring acceleration of the three-axis acceleration sensor according to the third exemplary embodiment of the present invention, in the case in which the three-axis acceleration sensor 210 includes a high frequency noise, a signal distortion caused by aliasing may be generated at the time of performing an analog-to-digital conversion by the analog-to-digital converter 260. Therefore, in order to remove the signal distortion, a low pass filter (LPF) needs to be placed at a front of the analog-to-digital converter 260.

However, in the case in which the signal becomes sufficiently stable and when there is no time during which the low pass filter is operated, a phenomenon in which the signals of the X, Y, and Z axes are mixed in the low pass filter occurs. Therefore, each of the signals needs to separately be low pass filtered and the low pass filtered value needs to be stored using the sample and hold. A fourth exemplary embodiment of the present invention described below provides a circuit structure of simultaneously performing a function of the low pass filter (LPF) and a function of the sample and hold in consideration of the above-mentioned aspect.

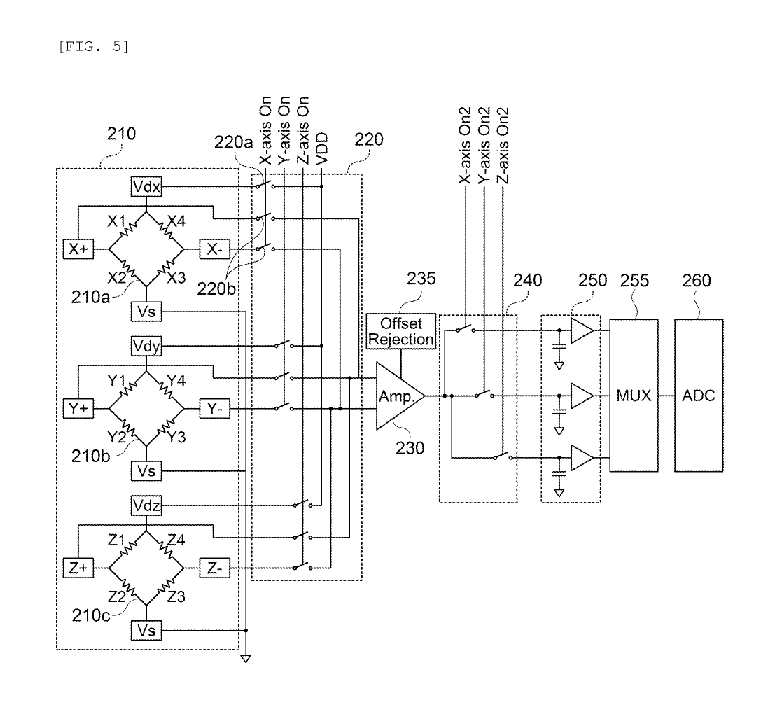

FIG. 5, which shows a configuration of a circuit for measuring acceleration of a three-axis acceleration sensor according to the fourth exemplary embodiment of the present invention, basically and equally includes the three-axis acceleration sensor 210, the demultiplexer 220, and the amplifier 230, similarly to the cases of the first to third exemplary embodiments of the present invention. Therefore, a description for the same components will be omitted and only different components will be described.

That is, the fourth exemplary embodiment of the present invention, which has a circuit structure approximately similar to a circuit structure of summing the second and third exemplary embodiments, further includes a multiplexer 240 distributing the signal output from the amplifier 230 so as to separately process the signal output from the amplifier 230 with respect to each of the X, Y, and Z axes, and a sample and hold circuit unit 250 sampling and an analog signal of each axis output from the multiplexer 240 and storing (maintaining) the analog signal between the amplifier 230 and the analog-to-digital converter 260 in the third exemplary embodiment of the present invention (see FIG. 4).

In this case, the sample and hold circuit unit 250 is further provided with a low pass filter unit for removing the high frequency noise mixed in the output signal from the three-axis acceleration sensor 210 receiving through the multiplexer 240. Here, the above-mentioned low pass filter unit may be configured of a resistor and a capacitor installed on a circuit line of each of the X, Y, and Z axes in the sample and hold circuit unit 250.

A second demuliplexer 255 receiving the signals of the three axes of X, Y, and Z from the sample and hold circuit unit 250 and outputting the signals through the single path may be further installed between the sample and hold circuit unit 250 and the analog-to-digital converter 260.

In the circuit for measuring acceleration of the three-axis acceleration sensor according to the fourth exemplary embodiment of the present invention having the above-mentioned configuration, ON driving signals (X-axis On2, Y-axis On2, and Z-axis On2) applied to the respective switches of the X, Y, and Z axes of the multiplexer 240 are applied later than ON driving signals (X-axis On, Y-axis On, and Z-axis On) applied to the respective switches of the X, Y, and Z axes of the demultiplexer 220, by a predetermined time. This is to operate the multiplexer 240 of the back-end after the respective switches of the X, Y, and Z axes of the demultiplexer 220 of the front-end are switched on and the signal output from the three-axis acceleration sensor 210 becomes stable to some degree.

In addition, as in the above-mentioned fourth exemplary embodiment of the present invention, noise folding generated by the sampling at the multiplexer 240 at an immediate front-end may also be decreased by using the circuit structure simultaneously performing the functions of the low pass filter (LPF) and the sample and hold (S&H). That is, the sample and hold circuit unit 250 having the low pass filter unit performs a function of an anti-aliasing filter necessary for each of the multiplexer 240 disposed at the front-end of the sample and hold circuit unit 250 and the analog-to-digital converter 260 disposed at the back-end of the sample and hold circuit unit 250.

According to the exemplary embodiment of the present invention, the consumption current of the circuit may be minimized by amplifying the signal from the three-axis acceleration sensor of X, Y, and Z axes through the single path and applying the driving voltage for driving the sensor only when driving the sensor.

In addition, the circuit of simultaneously performing the function of the low pass filter and the function of sampling and holding is provided to the front-end of the analog-to-digital converter, thereby making it possible to have the excellent noise characteristic.

Although the preferred embodiments of the present invention have been disclosed, the present invention is not limited thereto, but those skilled in the art will appreciated that various modifications, additions and substitutions are possible, without departing from the scope and sprit of the invention as disclosed in the accompanying claims. Therefore, the protection scope of the present invention must be analyzed by the appended claims and it should be analyzed that all spirits within a scope equivalent thereto are included in the appended claims of the present invention.

What is claimed is:

1. A circuit for measuring acceleration of a three-axis acceleration sensor, comprising:
three-axis acceleration sensors connected to one another in parallel and sensing the respective accelerations applied to three axes directions of X, Y, and Z axes to output corresponding signals;
a demultiplexer outputting three axes signals each output from the three-axis acceleration sensors through a single path; and
an amplifier amplifying the output signal from the demultiplexer.

2. The circuit for measuring acceleration of a three-axis acceleration sensor according to claim 1, wherein the demultiplexer has a switch for supplying a driving voltage and switches for opening and closing an output terminal of the three-axis acceleration sensor 220b configured of an interworking structure so that a voltage for driving the three-axis acceleration sensor is applied or blocked to the three-axis acceleration sensor, and the output terminal of the three-axis acceleration sensor is closed or opened.

3. The circuit for measuring acceleration of a three-axis acceleration sensor according to claim 1, further comprising, at an output terminal of the amplifier, a multiplexer distributing a signal output from the amplifier to the respective axes and a sample and hold circuit unit sampling and storing an analog signal of each axis output from the multiplexer.

4. A circuit for measuring acceleration of a three-axis acceleration sensor, comprising:
three-axis acceleration sensors connected to one another in parallel and sensing the respective accelerations applied to three axes directions of X, Y, and Z axes to output corresponding signals;
a demultiplexer outputting three axes signals each output from the three-axis acceleration sensors through a single path;
an amplifier amplifying the output signal from the demultiplexer; and
an analog-to-digital converter receiving an analog signal output from the amplifier, converting the analog signal into a digital signal, and outputting the digital signal.

5. The circuit for measuring acceleration of a three-axis acceleration sensor according to claim 4, wherein the demultiplexer has a switch for supplying a driving voltage and switches for opening and closing an output terminal of the three-axis acceleration sensor 220b configured of an interworking structure so that a voltage for driving the three-axis acceleration sensor is applied or blocked to the three-axis acceleration sensor, and the output terminal of the three-axis acceleration sensor is closed or opened.

6. The circuit for measuring acceleration of a three-axis acceleration sensor according to claim 4, wherein the amplifier is further installed with an offset rejection circuit for rejecting an offset in the case in which the three-axis acceleration sensor has the offset.

7. The circuit for measuring acceleration of a three-axis acceleration sensor according to claim 4, further comprising, between the amplifier and the analog-to-digital converter, a multiplexer distributing a signal output from the amplifier to the respective axes and a sample and hold circuit unit sampling and storing an analog signal of each axis output from the multiplexer.

8. The circuit for measuring acceleration of a three-axis acceleration sensor according to claim 7, wherein the sample and hold circuit unit is further provided with a low pass filter unit for removing a high frequency noise mixed in the output signal of the three-axis acceleration sensor received through the multiplexer.

9. The circuit for measuring acceleration of a three-axis acceleration sensor according to claim 7, wherein a second demultiplexer receiving three axes signals from the sample and hold circuit unit and outputting the three axes signals through a single path is further installed between the sample and hold circuit unit and the analog-to-digital converter.
